(19) United States
(12) Patent Application Publication
(10) Pub. No.: US 2026/0078633 A1
(43) Pub. Date: Mar. 19, 2026

(54) SEALING SYSTEM AND DOOR SYSTEM FOR A PIVOT DOOR

(71) Applicant: ALUMAT- Frey GmbH, Kaufbeuren (DE)

(72) Inventors: Claudia Rager-Frey, Kaufbeuren (DE); Stefan Anwander, Ettringen (DE)

(21) Appl. No.: 19/307,353

(22) Filed: Aug. 22, 2025

(30) Foreign Application Priority Data
Jun. 26, 2024 (DE) 10 2024 118 145.1

(51) Int. Cl. E06B 7/20

(52) U.S. Cl. CPC E06B 7/20

(57) ABSTRACT

A sealing system for a pivot door is provided. The system includes first and second elongate main bodies separated by a thermally insulating element, a rotary bearing for rotatable support of a door counter-bearing, and first and second seals. The separating element has a lower heat-transfer coefficient than the main bodies and is positioned between them to reduce thermal bridging. The first seal extends along the second main body, while the second seal is movable between open and closed states. In the closed state, the second seal extends along the sealing system, with the rotary bearing arranged both between the first and second seals and between the two main bodies. This configuration enhances sealing performance, provides thermal insulation, and ensures durable, rotatable support for pivot door installations.

### CROSS-REFERENCE TO RELATED APPLICATION

This application claims the benefit of and priority to Germany (DE) Patent Application No. 10 2024 118 145.1 filed Jun. 26, 2024.

### TECHNICAL FIELD

The disclosure presented relates to a sealing system and to a door system for a pivot door.

### BACKGROUND

Pivot doors constitute a particular type of swivel door which differ in principle from revolving doors, saloon doors or doors with push-to-open hinges and resemble pivotable wall elements.

In contrast to leaf-type doors, the fittings and hinges of pivot doors are not fastened laterally on the door leaf; rather, they are incorporated as a central or asymmetrical point of rotation in the door leaf.

In a pivot door, the door leaf is usually designed in the form of a vertical and inherently rigid plane which, when pushed, swings about a predefined vertical axis and thus creates an opening. It is therefore possible to dispense with knobs or door handles.

Door leaves of pivot doors can be up to 6 meters in height and up to 3 meters in width, that is to say they are far larger than conventional door leaves. For even wider openings, it is possible to combine a number of pivot doors with one another. A pivot-door weight of up to 1500 kg can pivot up to an opening angle of greater than 90 degrees.

Pivot doors are usually designed in the form of frames or skeletons, rather than monolithic elements such as for example solid wooden-door leaves. They range from frames with large-surface-area glazing to sandwich structures, which can be used both as internal doors and as external doors.

That pivot doors close correctly, do not require much maintenance and allow people to pass through in the long term is dependent essentially on the sealing system used.

### BRIEF SUMMARY

It is therefore an object of the disclosure presented to allow long-term and low-maintenance operation of a pivot door, in particular in old buildings.

The disclosure therefore presents, in accordance with a first aspect, a sealing system for a pivot door.

The sealing system presented comprises a first elongate main body, a second elongate main body, a rotary bearing, a separating element, a first seal and a second seal, wherein the first main body is mechanically coupled to the second main body by the separating element, wherein the rotary bearing is configured to bear a counter-bearing of a pivot door in a rotatable manner, wherein the separating element has a lower heat-transfer coefficient than the first main body and the second main body, wherein the separating element is arranged between the first main body and the second main body, wherein the first seal runs along a longitudinal axis of the second main body, wherein the second seal is movable between an open state and a closed state, wherein, in the closed state, the second seal runs along a longitudinal axis of the sealing system and the rotary bearing is located both between the first seal and the second seal and between the first main body and the second main body.

The disclosure presented is based on a multi-part sealing system which provides a rotary bearing for bearing a pivot door in a rotatable manner. In a closed position of the pivot door, this rotary bearing is protected against environmental influences by two seals, which together enclose the rotary bearing from two sides, i.e. from an exterior side of the pivot door and an interior side of the pivot door.

In particular, the seals provided according to the disclosure minimize any ingress of driving rain into the rotary bearing and/or into an interspace between the two seals, and so the sealing system presented is suitable in particular so that pivot doors can be fastened outdoors.

The multi-part design of the sealing system presented—with a first main body and a second main body—means that the sealing system can be used particularly straightforwardly and quickly in old buildings and new buildings alike, for example a width or a depth of the first main body and/or of the second main body being selected in accordance with a respective installation scenario.

It is also the case that the first main body and the second main body are thermally separated from one another by the separating element provided according to the disclosure, and this results in a so-called “warm sill”, i.e. dissipation of thermal energy from a heated interior into cold surroundings or, vice versa, introduction of thermal energy from warm surroundings into an air-conditioned interior is minimized.

The sealing system presented comprises a second seal, which is movable between an open state and a closed state. In the closed state, the second seal runs along a longitudinal axis of the sealing system, in particular parallel to a longitudinal axis of the second main body.

The second seal is optionally arranged on a respective pivot door and, accordingly, in the open state, it has been pivoted together with the pivot door and therefore does not run along the longitudinal axis of the sealing system.

Provision can be made for the first seal to comprise a magnetic strip, which can be deflected in a mount of the first main body, and a magnetic counter-strip, which is arranged on the pivot door, wherein the magnetic strip can be deflected such that it seals an interspace between the pivot door and the first main body in relation to a surrounding area.

A deflectable magnetic strip, i.e. one which is movable upward in the direction of a respective pivot door, means that if required, i.e. in a closed position of the pivot door, the region between the pivot door and the first main body is sealed and if required, i.e. in an open position of the pivot door, an essentially planar surface is provided, as a result of which it is possible to step safely, without any impediment, over the surface or the sealing system.

Provision can also be made for the second seal to comprise a flexible sealing lip, which is configured to seal an interspace between the pivot door and the second main body in relation to a surrounding area.

A flexible sealing lip, which consists for example of a rubber or a flexible plastic, can be in particular of a shape which is angled in the direction of a surrounding area, so that the angled shape imparts a force which counteracts movement of the sealing lip in the direction of the rotary bearing, for example caused by a gust of wind, and/or pushes the sealing lip against the first main body.

Provision can also be made for the rotary bearing to be screwed, adhesively bonded, riveted and/or clamped to the first main body and/or the second main body.

The rotary bearing can be connected to the first main body and the second main body in any mechanically suitable manner.

Provision can also be made for the first main body to comprise a mount, which, by means of a stop, secures the first seal in a movable manner in the first main body, wherein the mount is configured to receive the first seal such that the latter forms a planar surface with the first main body.

A stop, such as for example an overhang or protrusion in the first mount, prevents the first seal or the magnetic strip thereof from becoming detached from the first main body.

For the purpose of receiving the first seal such that the latter forms a planar surface with the first main body, the first mount can have at least a height which corresponds to the height of the first seal or the magnetic strip thereof.

Provision can also be made for the second main body to comprise a second mount, which is configured to receive at least part of the second seal.

The second mount can be for example a trough or recess, in which the second seal comes to bear when located in its closed position, so that any water which has possibly collected on the second seal is conducted away by way of the second mount, for example into a drainage channel.

Accordingly, provision can also be made for the sealing system to comprise a drainage channel for discharging water from the sealing system.

A drainage channel can comprise for example a bore in the first main body and/or the second main body or a specific geometry of the first main body and/or of the second main body, which discharges drainage water by way of a gradient.

Provision can also be made for a first insert element along a longitudinal axis of the first main body to be rotatably connected to the first main body, and for a second insert element along a longitudinal axis of the second main body to be rotatably connected to the second main body.

An insert element, such as for example a wing made of metal or some other solid material, makes it possible for the sealing system presented to be straightforwardly and quickly clamped in place in a predefined installation scenario, for example in old buildings, the insert element bridging a gap between the sealing system and the old building and, in the process, possibly compensating for a difference in height.

Provision can be made here for the first insert element and/or the second insert element to form a planar tread surface.

A planar tread surface is suitable in particular for installation scenarios in which there is no difference in height which has to be compensated for, a planar and impediment-free transition surface being the result.

As an alternative, provision can be made for the first insert element and/or the second insert element to form an at least partially rounded tread surface.

Rounded insert elements are particularly advantageously suitable for compensating for differences in height, since they distribute the difference in height uniformly over a radius and, accordingly, prevent any step-like elevation.

Provision can also be made for the sealing system to comprise a number of profiles, which cover over an interspace between the first main body and the second main body and form a planar surface both with the first main body and with the second main body.

Profiles or inserts which cover over an interspace between the first main body and the second main body can be used for example to adjust a distance between the first main body and the second main body. For this purpose, a profile can comprise coupling elements, such as for example latching noses, which engage in coupling interfaces or mounts of the first main body and of the second main body. For example, a profile can be releasably connected to the first main body and the second main body, in order to allow for maintenance of the sealing system.

In accordance with a second aspect, the disclosure presented relates to a door system for a pivot door, wherein the door system comprises a lower sealing system and/or an upper sealing system, wherein the lower sealing system and/or the upper sealing system are/is configured in accordance with the sealing system presented.

While a door sill or a lower sealing system is usually arranged on a floor, and forms a lower termination of the door system, a door trim or an upper sealing system usually forms an upper termination of a door frame.

Accordingly, provision can be made for the door system to comprise a door frame, which comprises the lower sealing system and/or the upper sealing system.

Provision can also be made for the door system to comprise a pivot door, wherein the pivot door comprises a magnetic strip, which is secured in a movable manner in the pivot door.

In the form of the first seal or part of the first seal, a magnetic strip arranged in a movable manner in particular on an upper edge of a pivot door can interact with a first main body of an upper sealing system of the door system presented, in order to protect a rotary bearing of the sealing system against environmental influences.

Provision can also be made for the second seal of a respective sealing system to be arranged on the pivot door.

A second seal, for example in the form of a sealing lip, which is arranged on the pivot door can interact with a second main body of a respective sealing system of the door system presented, in order to protect a rotary bearing of the sealing system against environmental influences.

Provision can also be made for the pivot door to weigh more than 200 kilograms, in particular more than 500 kilograms, optoinally more than 1000 kilograms.

The rotary bearing provided according to the disclosure means that the door system presented can comprise particularly heavy pivot doors, which would be too heavy for holders arranged on a wall.

### BRIEF DESCRIPTION OF THE FIGURES

Further features, details and advantages of the disclosure can be gathered from the wording of the claims and also from the following description of exemplary embodiments with reference to the drawings, in which:

FIG. 1 shows a possible configuration of the door system presented,

FIG. 2 shows a further view of the door system presented, and

FIG. 3 shows a sectional view through a further possible configuration of the door system presented.

### DETAILED DESCRIPTION

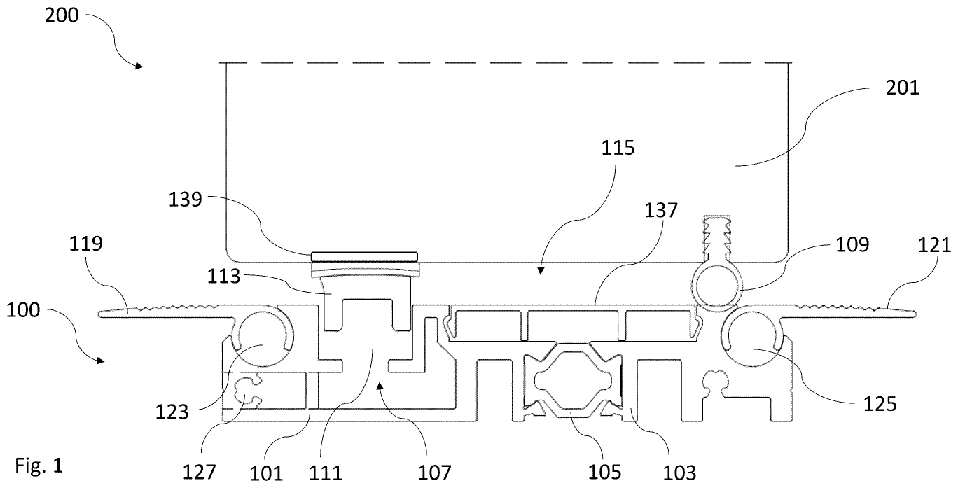

FIG. 1 illustrates a lower sealing system 100 of a door system 200. The door system 200 also comprises a pivot door 201.

The sealing system 100 comprises a first main body 101, a second main body 103, a rotary bearing (not illustrated here), a separating element 105, a first seal 107 and a second seal 109.

The separating element 105 is arranged between the first main body 101 and the second main body 103 and separates these thermally from one another.

The first seal 107 comprises a magnetic strip 113, which is arranged in a movable manner in a mount 111, so that the magnetic strip lifts up in the mount 111 when a magnetic counter-strip 139 of the pivot door 201 is located above it.

The pivot door 201 also bears a second seal 109, in the form of an elastic sealing lip, which moves along with the pivot door 201. Accordingly, the first seal 107 and the second seal 109 enclose an interspace 115, in which in the present case a profile 137 is illustrated. It is also possible for the rotary bearing of the sealing system 100 to be arranged in the interspace 115.

The profile 137 connects the first main body 101 to the second main body 103 to form a planar surface, and so the sealing system 100 forms an impediment-free surface when the pivot door 201 has been opened and the magnetic strip 113 is located in the mount 111.

Insert elements 119 and 121 are arranged in a rotatable manner on the first main body 101 and the second main body 103, respectively, and these insert elements allow the sealing system 100 to be straightforwardly and quickly introduced into a predefined installation space.

The insert elements 119 and 121 are mounted in a movable manner on spindles 123 and 125 of the first main body 101 and second main body 103, respectively, and, accordingly, are mechanically coupled thereto.

The first main body 101 comprises a drainage channel 127 for discharging water which is introduced into the sealing system 100 for example by way of the pivot door 201.

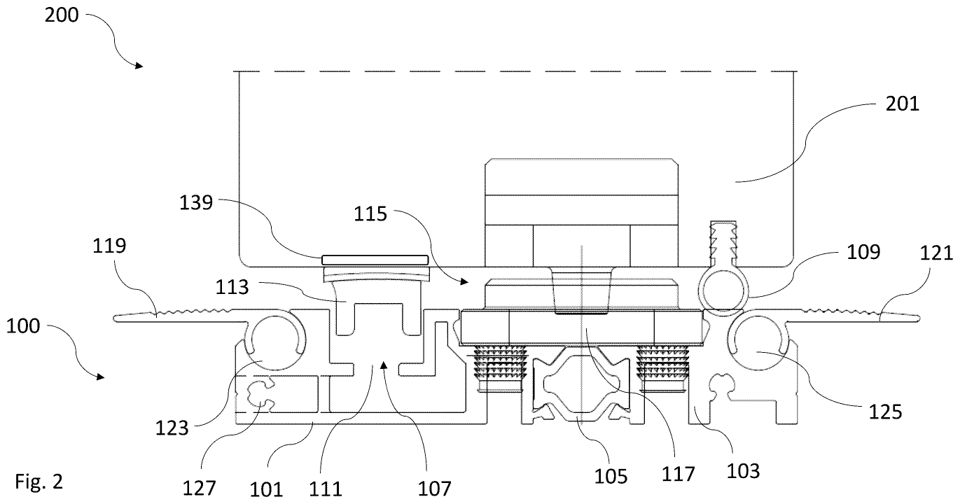

FIG. 2 clearly shows a rotary bearing 117 of the sealing system 100. The rotary bearing is arranged in the interspace 115 and, accordingly, is protected against environmental influences by the first seal 107 and the second seal 109.

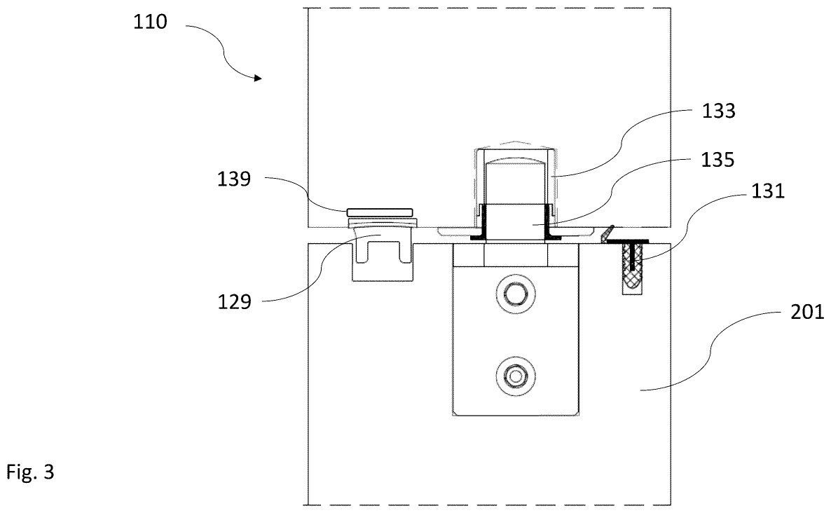

FIG. 3 shows an upper sealing system 110 of the door system 200, this sealing system being arranged above the pivot door 201. The sealing system 110 comprises a magnetic strip 129 and a sealing lip 131, which are integrated in the pivot door 201.

In a manner analogous to the lower sealing system 100, the sealing system 110 also comprises a first main body 101 and a second main body 103 as well as a rotary bearing 133, in which a counter-bearing 135 of the pivot door 201 engages. Accordingly, the pivot door 201 is mounted in a rotatable manner, and fastened in an installation space, by the two rotary bearings 117 and 133 of the sealing systems 100 and 110.

The magnetic strip 129 is attracted by a magnetic counter-strip 139, which is arranged on the first main body 101 of the sealing system 110. Accordingly, the magnetic strip 129, together with the magnetic counter-strip 139, forms the first seal 107 of the sealing system 110, and so the rotary bearing 133 is protected against environmental influences by the first seal 107 and the sealing lip 131, which forms the second seal 109 of the sealing system 110.

The disclosure is not restricted to one of the embodiments described above, but can be modified in various ways.

All of the features and advantages which can be gathered from the claims, the description and drawing, including structural details, spatial arrangements and method steps, may be essential to the disclosure both individually and in a wide variety of different combinations.

### LIST OF REFERENCE SIGNS

100 sealing system
101 first main body
103 second main body
105 separating element
107 first seal
109 second seal
110 sealing system
111 mount
113 magnetic strip
115 interspace
117 rotary bearing
119 insert element
121 insert element
123 spindle
125 spindle
127 drainage channel
129 magnetic strip
131 sealing lip
133 rotary bearing
135 counter-bearing
137 profile
139 magnetic counter-strip
200 door system
201 pivot door

1. A sealing system for a pivot door, wherein the sealing system comprises:
a first elongate main body,
a second elongate main body,
a rotary bearing,
a separating element,
a first seal, and
a second seal,
wherein the first main body is mechanically coupled to the second main body by the separating element,
wherein the rotary bearing is configured to bear a counter-bearing of a pivot door in a rotatable manner,
wherein the separating element has a lower heat-transfer coefficient than the first main body and the second main body,
wherein the separating element is arranged between the first main body and the second main body,
wherein the first seal runs along a longitudinal axis of the second main body,
wherein the second seal is movable between an open state and a closed state, and
wherein, in the closed state, the second seal runs along a longitudinal axis of the sealing system and the rotary bearing is located both between the first seal and the second seal and between the first main body and the second main body.

2. The sealing system as claimed in claim 1,
wherein the first seal comprises a magnetic strip which can be deflected in a mount of the first main body and a magnetic counter-strip, which is arranged on the pivot door, and
wherein the magnetic strip can be deflected such that it seals an interspace between the pivot door and the first main body in relation to a surrounding area.

3. The sealing system as claimed in claim 1, wherein the second seal comprises a flexible sealing lip, which is configured to seal an interspace between the pivot door and the second main body in relation to a surrounding area.

4. The sealing system as claimed in claim 1, wherein the rotary bearing is screwed, adhesively bonded, riveted, or clamped to the first main body or the second main body.

5. The sealing system as claimed in claim 1,
wherein the first main body comprises a mount, which, by means of a stop, secures the first seal in a movable manner in the first main body, and
wherein the first mount is configured to receive the first seal such that the latter forms a planar surface with the first main body.

6. The sealing system as claimed in claim 1, wherein the second main body comprises a second mount, which is configured to receive at least part of the second seal.

7. The sealing system as claimed in claim 1, wherein the sealing system comprises a drainage channel for discharging water from the sealing system.

8. The sealing system as claimed in claim 1,
wherein a first insert element on the first main body is rotatably connected to the first main body, and
wherein a second insert element on the second main body is rotatably connected to the second main body.

9. The sealing system as claimed in claim 8, wherein at least one of the first insert element and the second insert element form a planar tread surface.

10. The sealing system as claimed in claim 8, wherein at least one of the first insert element and the second insert element form an at least partially rounded tread surface.

11. The sealing system as claimed in claim 1, wherein the sealing system comprises a number of profiles, which cover over an interspace between the first main body and the second main body and form a planar surface both with the first main body and with the second main body.

12. A door system for a pivot door, wherein the door system comprises at least one of a lower sealing system and an upper sealing system comprising the sealing system as claimed in claim 1.

13. The door system as claimed in claim 12, wherein the door system comprises a door frame, which comprises at least one of the lower sealing system and the upper sealing system.

14. The door system as claimed in claim 12, wherein the door system comprises a pivot door, wherein the pivot door comprises a magnetic strip, which is secured in a movable manner in the pivot door.

15. The door system as claimed in claim 14, wherein the second seal of a respective sealing system is arranged on the pivot door.

16. The door system as claimed in claim 14, wherein the pivot door weighs more than 200 kilograms.

17. The door system as claimed in claim 14, wherein the pivot door weighs more than 500 kilograms.

18. The door system as claimed in claim 15, wherein the pivot door weighs more than 200 kilograms.

19. The door system as claimed in claim 15, wherein the pivot door weighs more than 500 kilograms.

20. The door system as claimed in claim 13, wherein the door system comprises a pivot door, wherein the pivot door comprises a magnetic strip, which is secured in a movable manner in the pivot door.
